(19) United States
(12) Patent Application Publication
(10) Pub. No.: US 2010/0031911 A1
(43) Pub. Date: Feb. 11, 2010

(54) DEVICE FOR STARTING AN INTERNAL COMBUSTION ENGINE, PARTICULARLY A DIESEL ENGINE

(76) Inventors: Bertrand Gessier, Les Essarts le Roi (FR); Claudiu Vasilescu, Paris (FR); Michael Chemin, Festigny (FR); Laurent Albert, Vallengoujard (FR); Philippe Colacicco, Paris (FR); Yohan Comorassamy, Cergy le Haut (FR); Benoit Dupeux, Oyeu (FR); Nicolas Labbe, Lyon (FR); Philippe Lutz, Le Vesinet (FR)

Correspondence Address: BERENATO & WHITE, LLC, 6550 ROCK SPRING DRIVE, SUITE 240, BETHESDA, MD, 20817, US

(21) Appl. No.: 12/441,089

(22) PCT Filed: Sep. 22, 2006
(86) PCT No.: PCT/FR2006/050929

§ 371 Date: Aug. 7, 2009

(51) Int. Cl. F02N 11/00; F02N 11/08; H02P 7/292

(52) U.S. Cl. 123/179.21; 290/38 R; 388/833

(57) ABSTRACT

A method and a device for starting a diesel engine with no heater plugs, comprising pistons and cylinders defining combustion chambers into which gases intended to participate in combustion are admitted, in which method a strategy is adopted whereby the gases present in the chambers are heated up in such a way as to raise them to a minimum temperature within the entire volume defined by the chambers when the pistons are in the position of maximum compression or close to that position. The gases are heated by compressing the air in the cylinders using an electrical machine, or using a heating system in the intake.

The invention concerns the field of internal combustion engines, particularly automobile vehicle diesel engines.

It concerns more particularly a method and device for starting an internal combustion engine including cylinders and pistons defining combustion chambers into which are admitted gases intended to participate in combustion.

It is known that internal combustion engines are started by an electric starter including a pinion adapted to mesh with a toothed ring gear constrained to rotate with the crankshaft, i.e. the engine shaft. The electrical machine can also drive the crankshaft via a front face belt.

Engine designers are seeking to reduce the compression ratio of diesel engines in order to respond to increasingly severe antipollution standards.

Moreover, starter devices of this type cause a number of problems with regard to starting an engine, particularly a diesel engine, in cold weather, especially when the temperature is less than or equal to −25° C.

It is known to provide preheating by means of a plurality of glowplugs (one in each combustion chamber) fixed to the cylinder head of the engine. These glowplugs generate a hot spot in the combustion chamber, which enables combustion of the injected diesel fuel, even at very low temperatures.

However, the system using glowplugs for preheating is localised and leads to an increase in fuel consumption on starting and to an increase in polluting emissions because combustion is incomplete and is not homogeneous. Moreover, the design of the cylinder head of the engine is compromised by the presence of the glowplugs, which occupy a large space and interfere with the circulation of gases inside the combustion chamber. The glowplugs are also costly.

Furthermore, after a cold start using glowplugs, the internal combustion engine tends to be very unstable when idling, which leads to a number of problems such as vibration, noise, etc. In some cases, the engine can eventually stall.

Moreover, present day starter systems cannot achieve drive speeds compatible with a low compression ratio.

The invention proposes a high-performance system for starting diesel engines with a low compression ratio.

It aims in particular to provide a method and a device for starting an internal combustion engine in cold weather, particularly at temperatures less than or equal to −25° C.

A further object of the invention is to provide a starting method and device of this kind that do not necessitate glowplugs in the combustion chambers. To this end the invention proposes a method of the type defined in the introduction in which a strategy is adopted whereby the gases present in the chambers are heated to a minimum temperature throughout the volume defined by the chambers when the pistons are in the maximum compression position or near it, notably within plus or minus 10° of it.

It has been observed that obtaining a certain temperature level, notably of around 415° C., substantially throughout the chamber enables reliable starting, including starting under difficult conditions. Moreover, the reduction in the compression ratio must be accompanied by an increase in the driving speed during the starting phase in order for the gases to reach the temperature necessary for self-ignition of the gases.

In a first embodiment, an electrical machine, notably an electric starter, is coupled to the crankshaft of the engine to drive it in rotation at a chosen rotation speed that is higher than a normal rotation speed and is obtained by said electrical machine in order to increase the compression of the air admitted into the cylinders of the engine and consequently the temperature in the cylinders. It is known that filling efficiency increases as the engine speed rises, to an optimum value around the maximum torque engine speed, and then decreases until the maximum engine speed is reached. This increase in compression linked to the increase in speed is explained among other things by a reduction in the rates of leakage between the pistons and the cylinders and by reduced heat exchanges between the (hot) gases contained in the combustion chamber and the (cold) walls of that chamber, and likewise a quantity of air introduced into the upper cylinder linked to an increase in the filling efficiency as the engine speed rises. This increase in the quantity of air admitted further produces an engine torque that is higher during starting, to overcome friction. This is because the work produced by the increase in pressure linked to combustion is directly linked to the quantity of fuel and air participating in combustion. There will therefore be an acceleration of the higher engine speed during starting linked to this additional work produced on each combustion cycle.

While the average rotation speed of a crankshaft driven by an electric starter at −25° C. is generally 110 revolutions per minute, the invention proposes to operate the electric starter at a higher rotation speed. This results in greater compression of the air despite a lower engine compression ratio and in operating conditions favourable to starting in cold weather, in any event to temperatures of the order of −25° C., because the quantity of air admitted into the cylinders of the engine is increased, thereby increasing the temperature in the cylinders. This is because the increase in the rotation speed of the electric starter, and thus of the crankshaft, is reflected in an increase in the linear speed of the pistons in the respective cylinders, leading to a reduction in leakage between the pistons and the cylinders and to reduced heat loss to the walls. The amount of leakage is proportional to the leakage time, and because the duration of the compression/expansion phase decreases as the engine speed increases, the amount of leakage likewise decreases.

The rotation speed chosen is advantageously greater than 200 revolutions per minute and more preferably greater than 300 revolutions per minute.

It is also possible to change the reduction ratio between the rotor of the electric starter and the crankshaft in order to increase the rotation speed of the engine, in particular to a reduction ratio less than 40:1.

A gear starter has between the armature shaft and the starter pinion an internal reduction gear stage the reduction ratio of which is around 3:1 and in all cases less than 4:1, ideally less than or equal to 3.84:1.

The engine ring gear preferably has a number of teeth less than or equal to 100.

The compression ratio of the engine is advantageously less than 16.5:1. At present the compression ratio for a diesel engine is approximately 17-18:1.

In another embodiment, the chambers being fed with gas intended to participate in combustion via a common pipe, said gases are preheated while flowing in said pipe, particularly during starting. This can reduce the starting time.

In this embodiment, said gases can be preheated and their flowrate adjusted simultaneously.

By combining the foregoing two embodiments the gases intended to participate in combustion can be preheated and said electrical machine operated at said chosen rotation speed in a coordinated manner.

More particularly, said gases can be preheated before operating said electrical machine at said chosen rotation speed.

This being the case, starting conditions can be detected and information deduced therefrom indicating a “cold start” or a “normal start”, and said strategy adopted depending on the starting conditions detected.

More particularly, the electrical machine can be actuated at the chosen speed or at the normal speed, respectively in the case of “cold start” conditions or “normal start” conditions.

The starting conditions relate, for example, to a temperature difference (DT=TH−T or DT=TE−T) between the temperature (TE) of the engine cooling water or the temperature (TH) of the engine lubricating oil and the temperature (T) of the outside air (ambient temperature), defining “cold start” conditions or “normal start” conditions according to whether this temperature difference (DT) is respectively less than or greater than a given threshold value (S), in particular 5° C., and the outside temperature (T) is respectively less than or greater than another given threshold value (S′), in particular 0° C.

The invention further concerns a starter device of the type defined in the introduction including means for heating the gases present in the chambers to a minimum temperature throughout the volume of the chambers when the pistons are in the maximum compression position or near it, notably within plus or minus 10° of it.

In a first embodiment, said preheating means consist of an electrical machine adapted to drive the crankshaft of the engine at a chosen rotation speed that is higher than a normal rotation speed obtained by said electrical machine in order to increase the compression of the air and the quantity of air admitted into the cylinders of the engine and consequently the temperature in the cylinders.

The invention envisages in particular using a standard electric starter, i.e. a starter able to operate at a given electrical voltage, for example 12 volts.

The resisting torque of the engine remaining substantially the same, increasing the power of the starter system in order to be able to increase the speed at which the engine is driven must be envisaged.

Present day starter systems may not be able to achieve sufficient driving speeds to start an engine with a low compression ratio. There is then provision for connecting the electric starter to an electrical circuit adapted to supply power to the starter at a boosted electrical voltage, i.e. a voltage higher than the given electrical voltage constituting the usual operating voltage of the starter.

The electrical circuit advantageously includes a primary voltage source adapted to deliver a nominal voltage of chosen value and a boosted voltage source adapted to deliver a voltage higher than the nominal voltage of the primary voltage source.

In a first variant, the boosted voltage source is a battery.

In one embodiment, the primary voltage source is a first battery adapted to deliver a nominal voltage of 12 volts and the boosted voltage source is a second battery adapted to deliver a nominal voltage of 24 volts. In this example, the 24 V boosted voltage source can advantageously be produced by connecting in series the first 12 V battery with a second 12 V battery with substantially identical characteristics.

In a second variant, the boosted voltage source is a supercapacitor, i.e. a double-layer capacitor, or an ultracapacitor.

In one embodiment, the primary voltage source is a first battery adapted to deliver a nominal voltage of 12 volts and the supercapacitor is adapted to deliver a voltage higher than 12 volts.

According to another feature of the invention, the electrical circuit includes a DC-DC converter for charging the boosted voltage source from the primary voltage source. This converter can be reversible or not.

The electrical circuit can also include an electrical relay adapted to operate the starter from the boosted voltage so

According to one variant, said circuit includes a first voltage source for delivering said nominal voltage, a second voltage source and switching means for combining said voltage sources to obtain said boosted voltage.

Thus two batteries can be used, for example of the same voltage, and a switching system for connecting said batteries in series or in parallel or for loading either both batteries or only one of them, depending on what is required.

It is desirable to have a value less than or equal to 4 mΩ for the sum of the internal resistances of the battery and that of the cable that supplies power to the electrical machine or the sum of the equivalent internal resistances of all the batteries that participate in supplying power to the electrical machine during starting and that of all their cables. This can be achieved by using a large battery or cables of large section.

Such a configuration is particularly suitable if starting conditions are identified by comparing T and TE or TH, as indicated above.

A battery could be used with a supercapacitor adapted to be connected in series with the battery.

The circuit could include a single battery for producing said nominal voltage and a DC-DC converter for producing said boosted voltage, notably an electronic chopper/booster device between the battery and the starter.

To facilitate starting, the starter control unit modifies the connections of the different batteries and/or the supercapacitor of said starter according to two distinct phases during starting as such: a first phase at a given voltage, and a second phase at a voltage higher than that of the first phase. This solution reduces power consumption during starting because the battery is discharged less than when the voltage delivered is constant throughout starting. It also has the advantage of allowing more starting attempts and therefore a greater chance of success under difficult conditions. Supercapacitors are able to deliver a high electrical power but, given their size, cannot contain much energy. In this solution of starting in two phases at two successive voltages, a supercapacitor of reduced size, for example 300 farads, is sufficient to assure the final phase of starting, in which a high speed is required to achieve the combustion temperature required in the combustion chambers, but only for a relatively short time, for example 1 to 3 revolutions of the crankshaft. When the temperature of the engine is low (less than 0° C. and even more so less than −20° C.), the pressure rise time of the injection rail is high. At such temperatures, the lubricating oil of the engine performs less well than when the engine is warm (water temperature approximately 80° C.). This causes an increase in the resisting torque of the engine. The starter system therefore drives the engine more slowly at low temperature than when the engine is warm. In many cases, the pump for pressurising the injection rail is driven by a mechanical system linked to the crankshaft of the engine (belt, chain, gear train, etc.). The rotation speed being proportional to that of the crankshaft, the pressure inside the injection rail therefore increases more slowly during starting at low temperature, the effect of which is to lengthen the starting time. Paradoxically, it is indispensable to be able to drive the engine as quickly as possible in order to reheat the gases in the combustion chamber sufficiently to produce combustion of the mixture and start the engine. In the end, power consumption during starting is very high because, during the first moments, in which the starter is driving the engine, the pressure in the injection rail is too low to be able to inject the minimum quantity of fuel required to cause an explosion of an intensity adapted to start the engine.

Another object of the present invention is to reduce the electrical power consumed by the starter system at the beginning of the phase of driving the engine and for as long as the pressure in the rail is too low. When a sufficiently high pressure is reached, the starting system is supplied with more power, enabling a very high rotation speed of the crankshaft to be achieved. This high speed leads to fast heating of the gases in the combustion chamber and thus to starting in a very short time.

The change between the first phase and the second phase is effected when the pressure in the injection manifold exceeds a threshold sufficient to enable first combustion in one of the cylinders in order to support starting. This conserves power at the beginning of starting, when the rotation speed is still low, to use it when the rotation speed rises, thus saving energy.

If starting is delayed, the change between the first phase and the second phase is effected when the duration of the first phase exceeds a certain time. This system is simple and enables starting without it being necessary to know the pressure in the injection manifold.

The duration of the first phase is a function of the outside temperature and/or the temperature of the engine cooling liquid. If that temperature is less than or equal to −20° the duration of the first phase is greater than or equal to one second.

If the starter machine is a gear starter driving an engine ring gear, the change between the first phase and the second phase is effected when the teeth of the starter pinion have begun partial or complete axial penetration into the teeth of the ring gear. This avoids milling of the ring gear.

In a different embodiment, the starter device instead or additionally includes preheating means that are adapted to preheat the inlet air and therefore the gases intended for combustion and are provided in the inlet system of the engine in a pipe feeding all the combustion chambers simultaneously.

In this embodiment, the preheating means include, for example, at least one electrically resistive element (R) which can be integrated into a valve incorporated in said pipe for adjusting the flowrate of the gases intended to participate in combustion.

Control means can then be provided for operating the preheating means and the electric starter in a coordinated manner. These control means are preferably adapted to operate the preheating means before the electric starter.

In one embodiment, the starter device includes detector means adapted to detect starting conditions and to deduce therefrom information indicating a “cold start” or a “normal start” and selector means connected to the detector means to actuate the electric starter respectively at the chosen speed or at the normal speed.

In other words, the device of the invention can start the engine in two different operating modes depending on the starting conditions detected.

The following description, which is given by way of example only, refers to the appended drawings, in which:

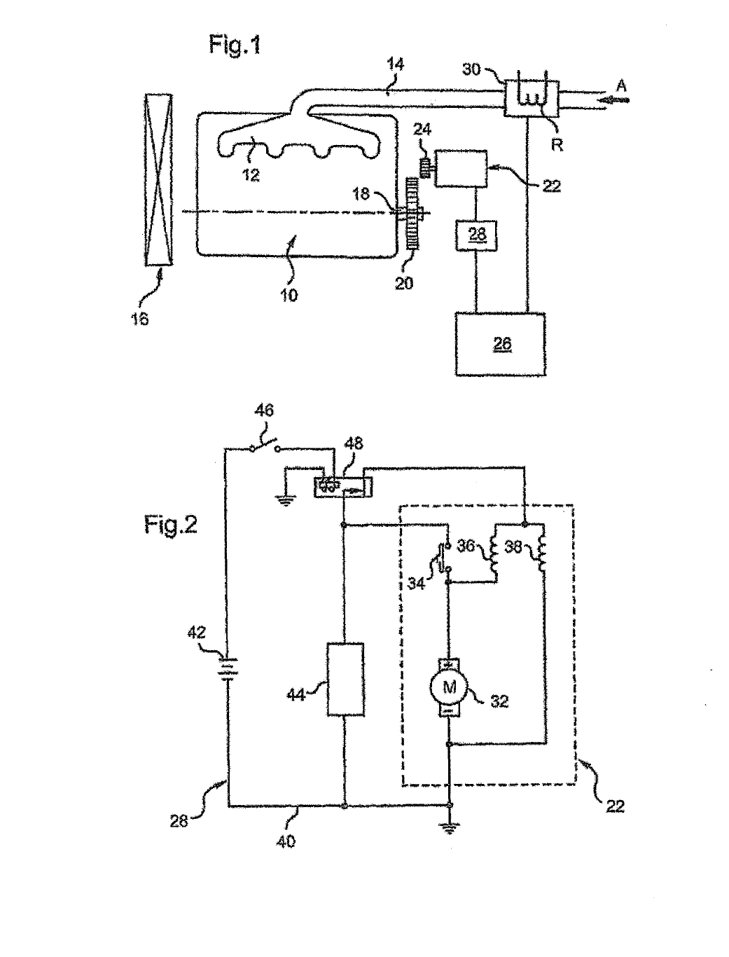

FIG. 1 is a diagram that represents an internal combustion engine with some of its standard ancillary equipment, the engine being equipped with a starter device of the invention;

FIG. 2 represents the electrical circuit diagram of a first variant of an electrical circuit for actuating the electric starter;

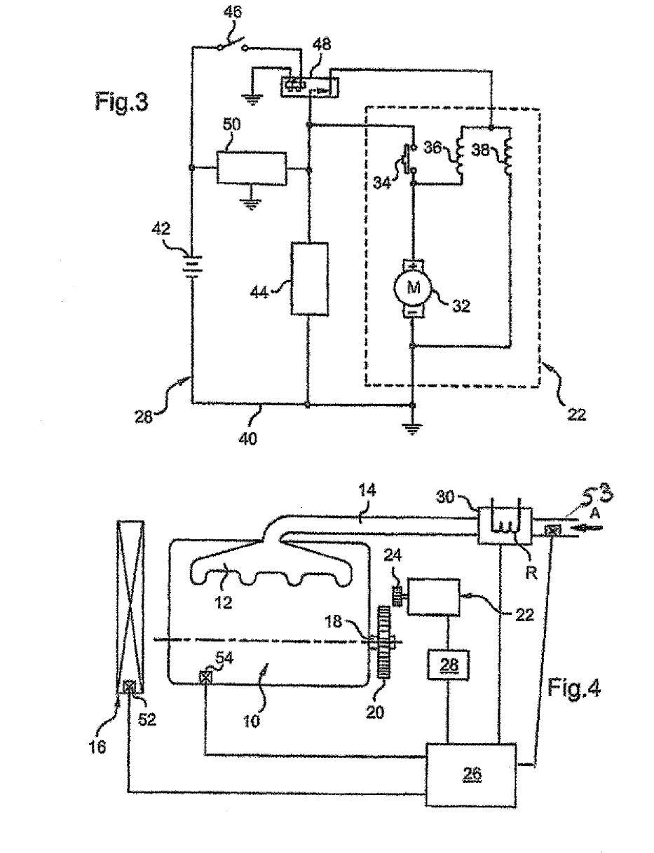

FIG. 3 is analogous to FIG. 2 for a second variant of the electrical circuit;

FIG. 4 is analogous to FIG. 1 for a different embodiment;

FIG. 5 is a flowchart of the operation of the control means of the FIG. 4 embodiment of the starter device;

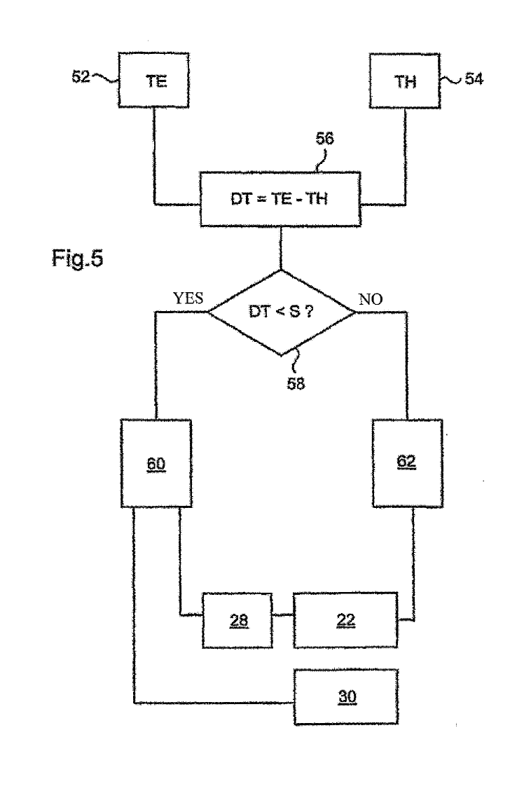

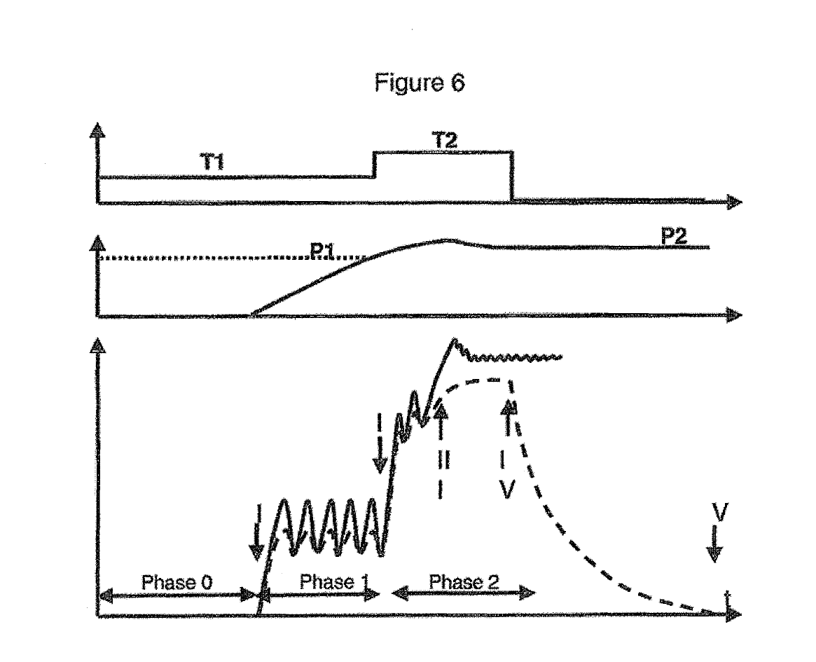

FIG. 6 represents the three-phase starting cycle;

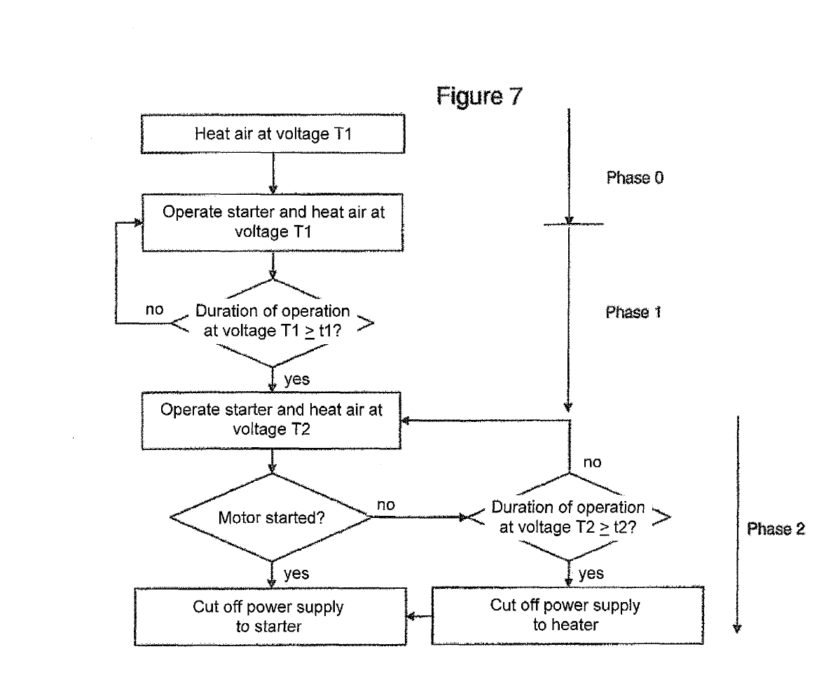

FIG. 7 is a flowchart of the operation of the control means corresponding to the three-phase starting cycle shown in FIG. 6;

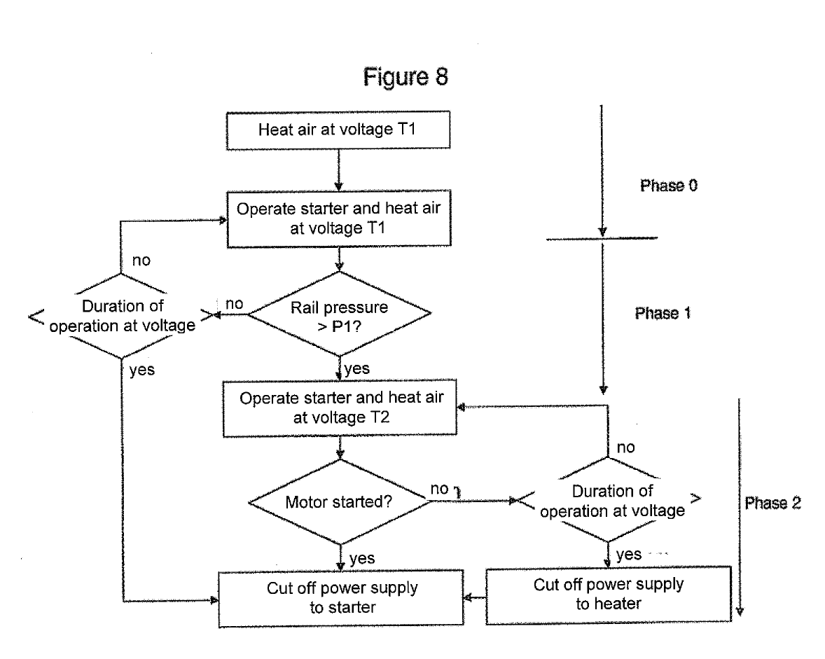

FIG. 8 is a flowchart of the operation of the control means of the device corresponding to a variant of the three-phase starting cycle shown in FIG. 6.

Refer first to FIG. 1, which shows an internal combustion engine 10, for example an automobile vehicle diesel engine, including an inlet manifold 12 adapted to admit a flow of inlet air A into the combustion chambers (not shown) of the engine from an inlet pipe 14. The manifold 12 and the pipe 14 together constitute the inlet system of the engine.

The engine 10 is cooled by a cooling liquid flowing in a cooling radiator 16. The engine 10 includes a crankshaft (or engine shaft) 18 to which a toothed ring gear 20 is keyed. In a manner known in the art, the engine is started by means of an electric starter 22 including a DC motor driving a toothed pinion 24 adapted to mesh with the toothed ring gear 20 upon axial displacement of the pinion. The electric starter 22 is a standard starter which, in this example, is designed to be driven by a voltage source of the usual kind, such as a battery delivering a nominal DC voltage of 12 volts.

According to the invention, the electric starter 22 is operated by means to be described later to drive the crankshaft 18 at a chosen rotation speed higher than the normal rotation speed. This chosen rotation speed is greater than 200 revolutions per minute in this example and preferably greater than 300 revolutions per minute, whereas the normal rotation speed achieved by the starter in cold weather is usually 110 revolutions per minute.

To this end, control means 26 (represented diagrammatically) operate the electric starter 22 at this chosen rotation speed via an electrical circuit 28 to be described later.

As indicated above, driving the crankshaft 18 at a higher rotation speed increases the compression of the admitted air and the quantity of air admitted into the cylinders of the engine and consequently the temperature in the cylinders, which makes it easier to start the engine in cold weather.

To make starting easier, it is advantageous also or instead to provide, as shown in FIG. 1, preheating means 30 adapted to preheat the inlet air A. These preheating means advantageously include an electrically resistive element R. Here they are disposed on the upstream side of the inlet manifold 12 of the engine, i.e. on the inlet pipe 14. Other locations are possible, for example at the entry of the inlet distributor of the engine or at the air inlet of each combustion chamber of the engine.

The control means 26 operate the preheating means 30 and the electric starter 22 in a coordinated manner. These means 26 and 30 can be operated simultaneously, but are preferably operated with a time shift. It is advantageous for the control means to operate the preheating means 30 before they operate the electric starter 22, for example at the time of an instruction to unlock the doors of the vehicle whose engine is to be started.

Because of this, the standard preheating system using glowplugs in the combustion chambers of the cylinders can be dispensed with. This results in a simplification of the cylinder head of the engine. Note, moreover, that the preheating system 30 is no more demanding of electrical power than a standard preheating system using glowplugs.

Refer next to FIG. 2, which shows one embodiment of an electrical circuit associated with the electric starter of the invention. The electric starter 22, represented diagrammatically here by a dashed outline rectangle, includes, in a manner that is known in the art, a direct current motor 32, a contactor 34, a pull-in winding 36 and a hold-in winding 38. The pull-in winding 36 causes the contactor 34 to pick up while the hold-in winding 38 holds the contactor in the closed state.

The electric starter 22 is connected to the electrical circuit 28 mentioned above, which includes a circuit 40 incorporating a primary voltage source 42 and a boosted voltage source 44. In this example, the source 42 is a first battery adapted to deliver a nominal DC voltage of 12 volts and the boosted voltage source 44 is a second battery adapted to deliver a nominal DC voltage of 24 volts. The 24 V boosted voltage source can also be produced by connecting the first 12 V battery in series with a second 12 V battery having substantially identical characteristics.

The circuit 28 includes a starter contactor 46 adapted to be actuated by an ignition key or a contact card to start the engine. The contactor 46 is supplied with power by the source 42, and therefore at a voltage of 12 volts in this example. An electrical relay 48 is included in the circuit 28 after the contactor 46 so that the starter can be operated from the boosted voltage source 44, i.e. here at 24 volts.

Accordingly, at the time of a start request, closure of the starter contactor 46 operates the relay 48 which in turn operates the starter from the boosted voltage source 44, i.e. at 24 volts. The circuit 28 thus supplies the electric starter 22 with power at a voltage higher than the usual voltage, enabling it to assume a higher rotation speed, as already explained.

The boosted voltage source 44 can be replaced by means other than a 24-volt battery, provided that such means are able to deliver a voltage higher than the nominal voltage of the primary source 42. Thus in one variant a supercapacitor can be used, i.e. a double-layer capacitor. It is known that these capacitors have a much greater active area than conventional capacitors, resulting in very high capacitance values. These supercapacitors also have the advantage of charging much faster than the usual batteries and of supplying a current of very high power.

Refer now to FIG. 3, which shows a variant of the circuit from FIG. 2. The difference here lies in the fact that the electrical circuit 40 further includes a DC-DC type converter 50 for charging the boosted voltage source 44 from the primary voltage source 42. This converter 50 is inserted between two branches of the circuit 40 that respectively include the voltage sources 42 and 44. This applies regardless of the type of boosted voltage source 44 used (battery, supercapacitor, etc.).

Refer now to FIG. 4, which shows a variant of the engine and its environment shown in FIG. 1. Here the main difference lies in the fact that the control means 26 are connected to detector means for detecting the starting conditions. More particularly, these detector means include a temperature sensor 53 for sensing the temperature of the air external to the vehicle, a temperature sensor 52 for sensing the temperature (TE) of the engine cooling water or a temperature sensor 54 for sensing the temperature (TH) of the engine lubricating oil. As explained later, it is thus possible to define different starting conditions, namely “cold start” conditions and “normal start” conditions, depending on the difference between the values T and TE or TH measured in this way.

Refer now to FIG. 5, which is a flowchart for the FIG. 4 embodiment. The sensors 52 and 54 are connected to a computer 56 which computes the temperature difference DT=T−TE or DT=T−TH. This computer is connected to a comparator 58 that compares the value DT to a threshold value S, for example of 5° C., and determines whether T is less than a threshold value S′, for example of 0° C. Two situations can then arise: if the value DT is less than the threshold value S and T is less than the threshold value S′, it is deduced that the cold starting conditions apply. On the other hand, if the value DT is greater than the threshold value S or T is greater than the threshold value S′, it is deduced that normal starting conditions apply.

Thus the comparator 58 constitutes selector means which, depending on the value of DT relative to S, command either a cold start or special start 60 or a normal start 62. In the case of a cold start 60, the control means operate the electric starter 22 via the electrical circuit 28 and the heating means 30 in a coordinated manner, as explained above.

In the case of a normal start 62, the control means 26 operate the electric starter 22 under the usual conditions, i.e. the starter is supplied with power at the nominal voltage of the primary voltage source 42. In other words, in this latter situation, the speed at which the crankshaft is driven corresponds to the usual conditions.

FIG. 6 shows the interaction of the various elements with each other, the first curve at the top representing the power supply voltage of the starter and the air preheater over time, the second curve in the middle showing the pressure in the injection rail over time, and the bottom curve showing in solid line the speed of the engine and in dashed line the speed of the starter.

During a phase 0, the air is preheated, during the first phase (phase 1) the starter is supplied with power at a voltage T1 (I), the voltage then changes to T2 (II) during the second phase (phase 2), the voltage returns to zero (IV) when the engine has started (III), the starter is disconnected and stops rotating (V).

The voltages T1 and T2 are substantially constant, but a slight continuous fall in T and/or T2 can occur during starting because the battery is gradually discharged.

The starting strategy can be different, depending on the circumstances: if the engine is started in cold weather, the voltage increases from T1 to T2, with T2≧T1, whereas if the engine is warm (water or oil temperature above a threshold, for example 50° C.) it is started in the standard way with a substantially constant power supply voltage substantially equal to 12 V.

If the vehicle is equipped with a “stop and start” system, which automatically stops the engine when the vehicle is stationary, starting at the command of the driver with the ignition key or the start button is effected at voltages T1 and T2, whereas automatic restarting is effected either at a substantially constant voltage or at voltages T1 and T2, with the duration of the preheating phase 0 and the duration of phase 1 at the voltage T1 depending on the conditions defined in the flowcharts of FIGS. 7 and 8.

The mode of operation of the control means of the two-stage starter device of the invention is described next.

First of all (phase 0), the air is preheated at a power supply voltage T1 for a duration that is determined depending on the temperature of the engine water or oil (first step in FIGS. 7 and 8). The duration of phase 1 (second step in FIGS. 7 and 8) during which the starter is operated and preheating is active at a voltage T1 is adjusted by an electronic control system, optionally included in the computer, in two different modes.

In the first mode, represented in FIG. 7, the duration t1 for which power is supplied is predetermined depending on the temperature of the engine water or oil (longer when the engine is cold) or the temperature of the outside air (longer when the outside temperature is lower). For example, for an outside air temperature equal to 20° C., the value of t1 can be set at approximately 0.2 seconds and the value of t2 at approximately 3 seconds, while for an outside air temperature equal to −25° C., the value of t1 can be set at approximately 1.5 seconds and the value of t2 at approximately 10 seconds.

In the second mode, represented in FIG. 8, phase 1 lasts until the pressure in the injection manifold has reached a pressure P1 that is the minimum pressure at which fuel can be injected into the cylinders concerned to produce an explosion in said cylinders of sufficient intensity to start the engine. The order of magnitude of P1 is from 50% to 80% of P2, which is the pressure set point under stable idling conditions. For example, if P2 is equal to 30 MPa, P1 will be equal to 20 MPa. If the pressure P1 has not been reached after a predetermined time t′1, for example of 10 s, then the supply of power to the heater and the starter is cut off.

At the end of this phase 1, the subsequent phases are identical for both the FIG. 7 and FIG. 8 modes. In phase 2, the power supply voltage is increased to T2 in order to reach a particularly high crankshaft rotation speed. The start of this phase 2 substantially corresponds to the start of injection of fuel into the cylinders. As soon as the crankshaft speed measuring means detect that the engine has started, the supply of power to the starter is cut off, although that to the heater can be continued, for example for a time of the order of 10 seconds to 10 minutes, in order to stabilise the idling speed. If starting of the engine has not been detected after a time t2 of 5 s, for example, the starter and the heater are disconnected.

The starter device of the invention has the following main advantages:
reduced polluting emissions because less fuel is used,
faster starting (and preheating),
fewer combustion failures,
reduced instability, and consequential noise, after starting,
simplified engine cylinder head, and
application to engines with a low compression ratio.

Furthermore, as already explained hereinabove, the inlet air preheating means do not require more electrical power than a system using glowplugs.

The invention finds a general application to internal combustion engines and very specifically to automobile vehicle diesel engines.

1. Method of starting without glowplugs a diesel engine including cylinders and pistons defining combustion chambers into which are admitted gases intended to participate in combustion, in which method a strategy is adopted whereby the gases present in the chambers are heated to a minimum temperature throughout the volume defined by the chambers when the pistons are in or near the maximum compression position.

2. Method according to claim 1, wherein said minimum temperature is approximately 415° C.

3. Method according to claim 1 wherein said engine including a crankshaft (18), an electrical machine (22) is coupled to the crankshaft to drive it in rotation at a chosen rotation speed that is higher than a normal rotation speed and is obtained by said electrical machine in order to increase the compression of the air present in the cylinders of the engine and consequently the temperature in the cylinders.

4. Method according to claim 3, wherein the chosen rotation seed is greater than 200 revolutions per minute.

5. Method according to claim 4, wherein the chosen rotation seed is greater than 300 revolutions per minute.

6. Method according to claim 1, wherein the total reduction ratio between the rotor of the electrical machine (22) and the crankshaft is less than 40:1.

7. Method according to claim 1, wherein the starter is of the gear type and has between the rotor shaft and the starter pinion an internal reduction gear stage the ratio whereof being less than 4:1.

8. Method according to claim 7, wherein the engine ring gear has a number of teeth less than or equal to 100.

9. Method according to claim 1, wherein the compression ratio of the engine is less than or equal to 16.5:1.

10. Method according to claim 1, wherein the chambers being supplied with gases intended to participate in combustion via a common pipe, said gases are preheated while flowing in said pipe.

11. Method according to claim 10, wherein said gases are preheated and their flowrate is adjusted simultaneously.

12. Method according to claim 3, wherein the gases intended to participate in combustion are preheated and said electrical machine (22) is operated at said chosen rotation speed in a coordinated manner.

13. Method according to claim 10, wherein said gases are preheated before operating said electrical machine at said chosen rotation speed.

14. Method according to claim 1, wherein starting conditions are detected, information is deduced relating to “cold start” conditions or “normal start” conditions and said strategy is adopted depending on said starting conditions.

15. Method according to claim 3, wherein the electrical machine (22) is operated at the chosen speed or at the normal speed according to whether the “cold start” conditions or the “normal start” conditions, respectively, apply.

16. Method according to claim 14, wherein the starting conditions relate to:
a temperature difference (DT=T−TE) between the temperature (T) outside the vehicle and the temperature (TE) of the engine cooling water or the temperature (TH) of the engine lubricating oil, and
the outside temperature T and define the “cold start” conditions or the “normal start” conditions according to whether that temperature difference (DT) or the temperature (T) are respectively less than or greater than a given threshold value (S) or (S′).

17. Starting method according to claim 16, wherein the threshold value (S) is 5° or the threshold value (S′) is 0° C.

18. Device for starting without glowplugs a diesel engine including cylinders and pistons defining combustion chambers into which are admitted gases intended to participate in combustion, said device including means for heating the gases present in the chambers to a minimum temperature throughout the volume of the chambers when the pistons are in or near a position of maximum compression.

19. Device according to claim 18 including an electrical machine (22) adapted to be coupled to the crankshaft (18) of the engine to drive it in rotation at a chosen rotation speed that is higher than a normal rotation speed obtained by said electrical machine in order to increase the compression and the quantity of air admitted into the cylinders of the engine and consequently the temperature in the cylinders.

20. Device according to claim 19, wherein said electrical machine (22) is an electric starter that is adapted to operate at one or more given electrical voltages and is connected to an electrical circuit (28) adapted to supply power to the starter at a boosted electrical voltage higher than the given electrical voltage.

21. Device according to claim 19, wherein the electrical circuit (28) includes a primary voltage source (42) adapted to deliver a nominal voltage of chosen value and a boosted voltage source (44) adapted to deliver a voltage higher than the nominal voltage of the primary voltage source (42).

22. Device according to claim 21, wherein the boosted voltage source (44) is a battery.

23. Device according to claim 21, wherein the primary voltage source (42) is a battery adapted to deliver a nominal voltage of 12 volts and the boosted voltage source (44) is a battery adapted to deliver a nominal voltage of 24 volts.

24. Device according to claim 22, wherein the boosted voltage source (44) is a supercapacitor.

25. Device according to claim 21, wherein the primary voltage source (42) is a battery adapted to deliver a nominal voltage of 12 volts and the boosted voltage source (44) is a supercapacitor adapted to deliver a voltage higher than 12 volts.

26. Device according to claim 21, wherein the electrical circuit (28) includes a DC-DC converter (50) for charging the boosted voltage source (44) from the primary voltage source (42).

27. Device according to claim 21, wherein the electrical circuit (28) includes an electrical relay (48) adapted to operate the electric starter (22) from the boosted voltage source (44).

28. Device according to claim 18, wherein said circuit includes a first voltage source for delivering said given voltage, a second voltage source and switching means for combining said voltage sources to obtain said boosted voltage.

29. Device according to claim 18, wherein said circuit includes a single battery for producing said given voltage and a DC-DC converter for producing said boosted voltage.

30. Device according to claim 20, wherein the starting process includes a first phase in which the starter is supplied with power at a given voltage and a second phase in which said starter is supplied with power at a voltage higher than the given voltage.

31. Device according to claim 30, wherein the change between the first phase and the second phase is effected when the pressure in the injection manifold exceeds a defined threshold.

32. Device according to claim 30, wherein the change between the first phase and the second phase is effected when the duration of the first phase exceeds a certain time.

33. Device according to claim 32, wherein the duration of the first phase is a function of the outside temperature and/or the temperature of the engine cooling liquid.

34. Device according to claim 33, wherein if the temperature is less than or equal to 20° C. the duration of the first phase is 1 s.

35. Device according to claim 30, wherein when the starter has a pinion cooperating with a ring gear, the change between the first phase and the second phase is effected when the pinion has begun its penetration into the teeth of the ring gear.

36. Device according to claim 18, including preheating means (30) that are adapted to preheat the gases intended for combustion, referred to as the inlet air (A), said preheating means being provided in a pipe feeding all the combustion chambers simultaneously.

37. Device according to claim 30, wherein the preheating means (30) include at least one electrically resistive element (R).

38. Device according to claim 31, wherein said electrically resistive element (R) is integrated into a valve for adjusting the flowrate of the gases intended to participate in combustion, said valve being provided in said pipe.
